(19) United States
(12) Patent Application Publication
(10) Pub. No.: US 2022/0068287 A1
(43) Pub. Date: Mar. 3, 2022

(54) SYSTEMS AND METHODS FOR MODERATING NOISE LEVELS IN A COMMUNICATION SESSION

(71) Applicant: AVAYA MANAGEMENT LP, Santa Clara, CA (US)

(72) Inventors: Pushkar Yashavant Deole, Pune (IN); Sandesh Chopdekar, Pune (IN); Navin Daga, Silapathar (IN)

(21) Appl. No.: 17/008,386

(22) Filed: Aug. 31, 2020

(51) Int. Cl. G10L 21/0208; G10L 25/30; H04M 3/56; H04N 7/15; G10L 21/028

(52) U.S. Cl. CPC G10L 21/0208; G10L 25/30; G10L 21/028; H04N 7/152; H04M 3/569

(57) ABSTRACT

Systems and methods of the present disclosure include receiving, with a processor, audio from a first user device associated with a first user participating in the communication session; determining, by the processor, the audio comprises a level of noise; determining, by the processor, the level of noise exceeds a threshold level; and based on determining the level of noise exceeds the threshold level, one or more of generating, by the processor, a warning for the first user and generating, by the processor, a graphical illustration of the level of noise for the first user in the communication session.

### FIELD

The disclosure relates generally to communication applications and particularly to reducing issues relating to excessive noise in a communication session.

### BACKGROUND

As electronic user devices such as smart phones, tablets, computers, etc., become more commonplace, more and more communication between people occurs via remote voice and video communication applications such as FaceTime, Skype, Zoom, GoToMeeting, etc. More and more users all over the world are adopting a remote working culture. In order to collaborate effectively, users make use of a number of voice/video conferencing solutions. Besides simple one-to-one communication sessions, voice and video communication often takes place between a large number of people. For example, business meetings are often conducted without requiring participants to be physically present in a room.

Voice and video communication over the Internet has enabled real-time conversations. One communication session may take place between many participants. Each participant may have his or her own camera and/or microphone through which to be seen by and to speak to the other participants. In many contemporary video and/or audio communication applications, there is no limit to the number of participants, each of whom may speak at any time.

While the ability for participants to speak during a communication session at any time provides a great potential for efficient communication, always-on microphones carry some negative aspects. It is quite common for a large number of users to participate in a business meeting or technical discussion meeting. When users work remotely, users are often surrounded by noise sources which are not under the control of the user. For example, microphones can pick up sounds other than the voice of a user such as background noise. Microphones can also pick up sounds from speakers which may cause a feedback loop. Secondly, the user is not aware that s/he is carrying all those background sounds whenever s/he is contributing content to the conference which contributes a mixed content of user's voice and background noises to the conference. The noises could be dog barking, vehicle honking, or even vehicles just passing by.

Such noises reduce the quality of experience to the participants of the conference as some or all of participants cannot collect information shared by other users, resulting in lost information which breaks the continuity or flow of a conference. Such noises and feedback can greatly limit the enjoyability and effectiveness of a communication session. Moreover, the transmission of unnecessary noises in a communication session is at the expense of bandwidth. Noise mixed along with human voice consumes more bandwidth of a user's network. Excessive noises transmitted during a communication session can limit the bandwidth available for the desirable voices during the communication session.

Mute buttons enable users to logically turn off the transmission of audio from a user device participating in a communication session. Mute buttons, however, require users to actively be aware of when noises are or may be an issue. Moreover, when a user wants to communicate to a meeting, the user cannot be on mute. As such, users must pay constant attention to their own sound levels and whether they are on mute. As a result, it is not reasonable to assume users will properly activate a mute button when needed. Furthermore, requiring users to pay attention to the existence of excessive external noises and the sources of the noises is akin to asking users to pay attention to matters not at the focus of the communication session. Such a task limits the ability of users to focus on the matters at hand during the call, limiting the overall effectiveness of the communication.

What is needed is a communication system capable of resolving the above described issues with conventional communication systems.

### BRIEF DESCRIPTION OF THE DRAWINGS

FIG. 1 is a block diagram of a first illustrative system for implementing a communication session in accordance with one or more embodiments of the present disclosure;

FIG. 2A is a block diagram of a user device system for executing a communication session in accordance with one or more embodiments of the present disclosure;

FIG. 2B is a block diagram of a server for executing a communication session in accordance with one or more embodiments of the present disclosure;

FIG. 3A is an illustration of a user interface in accordance with one or more embodiments of the present disclosure;

FIG. 3B is an illustration of a user interface in accordance with one or more embodiments of the present disclosure;

FIG. 4 is an illustration of a user interface in accordance with one or more embodiments of the present disclosure;

FIG. 5 is an illustration of a user interface in accordance with one or more embodiments of the present disclosure;

FIG. 6A is an illustration of a user interface in accordance with one or more embodiments of the present disclosure;

FIG. 6B is an illustration of a user interface in accordance with one or more embodiments of the present disclosure;

FIG. 7 is a flow diagram of a process in accordance with one or more embodiments of the present disclosure; and

FIG. 8 is a flow diagram of a process in accordance with one or more embodiments of the present disclosure.

### DETAILED DESCRIPTION

The above discussed issues with contemporary communication applications and other needs are addressed by the various embodiments and configurations of the present disclosure. As described herein, audio in an audio-only or audio-visual communication session may be monitored for excessive noise. When excessive noise is detected a warning may be displayed. Warnings may be adjusted based on situations. For example, a computer system may be capable of identifying a source of the noise and displaying a recommendation for ending the noise. In addition to warnings regarding excessive noise, any noise level can be indicated at any time to any participant in a communication session. In some embodiments, different color codes may be used based on different amounts of noise. For example, green may represent a user's audio contains a minimal or acceptable level of noise, orange may represent the user's audio is moving towards a noisy zone, and red may represent the user should take immediate corrective action. In some embodiments, the computer system may generate a continuous graphical indicator providing information about overall noise contribution from a user device. The indicator may be displayed on the user device in the form of a graph or gauge. For example, if noise is existent in audio captured by a user device participating in a communication session, an indicator may be displayed showing the level of noise in the user's audio. The level of noise may be determined based on an analysis of audio content other than voice in the audio from the user device. The audio of the user device may be sent to a server hosting the communication session. The server may be capable of analyzing the audio to identify a ratio of noise to voice. As discussed below, some embodiments may employ other features to ensure satisfactory audio levels during a communication session. Such a system as described herein provides a rich experience to the user.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

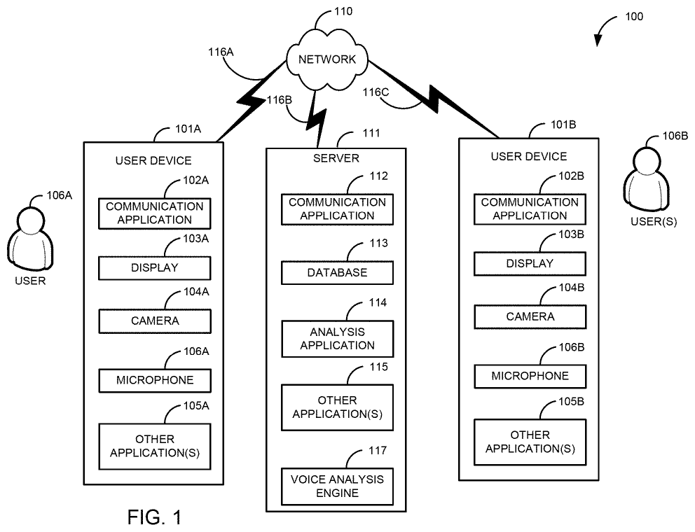

FIG. 1 is a block diagram of a first illustrative system 100 for communication session between one or more users in accordance with one or more of the embodiments described herein. The first illustrative system 100 comprises user communication devices 101A, 101B and a network 110. In addition, users 106A-106B are also shown.

The user communication devices 101A, 101B can be or may include any user device that can communicate on the network 110, such as a Personal Computer (“PC”), a video phone, a video conferencing system, a cellular telephone, a Personal Digital Assistant (“PDA”), a tablet device, a notebook device, a smartphone, and/or the like. The user communication devices 101A, 101B are devices where a communication session ends. Although only two user communication devices 101A, 101B are shown for convenience in FIG. 1, any number of user communication devices 101 may be connected to the network 110 for establishing a communication session.

The user communication devices 101A, 101B may each further comprise communication applications 102A, 102B, displays 103A, 103B, cameras 104A, 104B, and microphones 106A, 106B. It should be appreciated that, in some embodiments, user devices may lack cameras 104A, 104B. Also, while not shown for convenience, the user communication devices 101A, 101B typically comprise other elements, such as a microprocessor, a microphone, a browser, other applications, and/or the like.

In addition, the user communication devices 101A, 101B may also comprise other application(s) 105A, 105B. The other application(s) 105A can be any application, such as, a slide presentation application, a document editor application, a document display application, a graphical editing application, a calculator, an email application, a spreadsheet, a multimedia application, a gaming application, and/or the like. The communication applications 102A, 102B can be or may include any hardware/software that can manage a communication session that is displayed to the users 106A, 106B. For example, the communication applications 102A, 102B can be used to establish and display a communication session.

The displays 103A, 103B can be or may include any hardware display/projection system that can display an image of a video conference, such as a LED display, a plasma display, a projector, a liquid crystal display, a cathode ray tube, and/or the like. The displays 103A-103B can be used to display user interfaces as part of communication applications 102A-102B.

The microphones 106A, 106B may comprise, for example, a device such as a transducer to convert sound from a user or from an environment around a user communication devices 101A, 101B into an electrical signal. In some embodiments, microphone 106A, 106B, may comprise a dynamic microphone, a condenser microphone, a contact microphone, an array of microphones, or any type of device capable of converting sounds to a signal.

The user communication devices 101A, 101B may also comprise one or more other application(s) 105A, 105B. The other application(s) 105A, 105B may work with the communication applications 102A, 102B.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), H.323, video protocol, video protocols, Integrated Services Digital Network (ISDN), and the like. Thus, the network 110 is an electronic communication network configured to carry messages via packets and/or circuit switched communications.

The network may be used by the user devices 101A, 101B, and a server 111 to carry out communication. During a communication session, data 116A, such as a digital or analog audio signal or data comprising audio and video data, may be sent and/or received via user device 101A, data 116B may be sent and/or received via server 111, and data 116C may be sent and/or received via user device 101B.

The server 111 may comprise any type of computer device that can communicate on the network 110, such as a server, a Personal Computer (“PC”), a video phone, a video conferencing system, a cellular telephone, a Personal Digital Assistant (“PDA”), a tablet device, a notebook device, a smartphone, and/or the like. Although only one server 111 is shown for convenience in FIG. 1, any number of servers 111 may be connected to the network 110 for establishing a communication session.

The server 111 may further comprise a communication application 112, database(s) 113, analysis applications 114, other application(s) 115, and, while not shown for convenience, other elements such as a microprocessor, a microphone, a browser application, and/or the like.

In some embodiments, a server 111 may comprise a voice analysis engine 117. The voice analysis engine 117 may be responsible for voice analysis and processing. For example, upon receiving an audio signal from a user device 101A, 101B, participating in a communication session, the voice analysis engine 117 may process the audio signal to filter or otherwise separate audio including a user's voice from noise such as background noise. The voice analysis engine 117 may execute one or more artificial intelligence algorithms or subsystems capable of identifying human voice or otherwise distinguishing between voice and other noises.

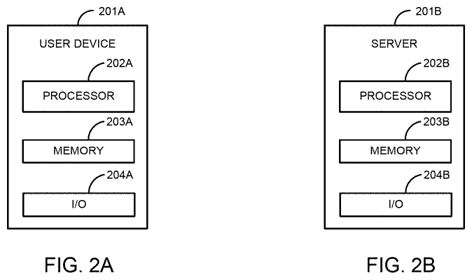

FIGS. 2A and 2B illustrate components of an exemplary user device 201A and server 201B for use in certain embodiments as described herein.

In some embodiments, a user device 201A may comprise a processor 202A, memory 203A, and input/output devices 204A. Similarly, a server 201B may comprise a processor 202B, memory 203B, and input/output devices 204B.

A processor 202A, 202B may comprise a processor or microprocessor. As used herein, the word processor may refer to a plurality of processors and/or microprocessors operating together. Processors 202A, 202B may be capable of executing software and performing steps of methods as described herein. For example, a processor 202A, 202B may be configured to display user interfaces on a display of a computer device. Memory 203A, 203B of a user device 201A, 201B may comprise memory, data storage, or other non-transitory storage device configured with instructions for the operation of the processor 202A, 202B to perform steps described herein. Accordingly, processes may be embodied as machine-readable and machine-executable code for execution by a processor to perform the steps herein and, optionally, other processing tasks. Input/output devices 204A, 204B may comprise, but should not be considered as limited to, keyboards, mice, microphones, cameras, display devices, network cards, etc.

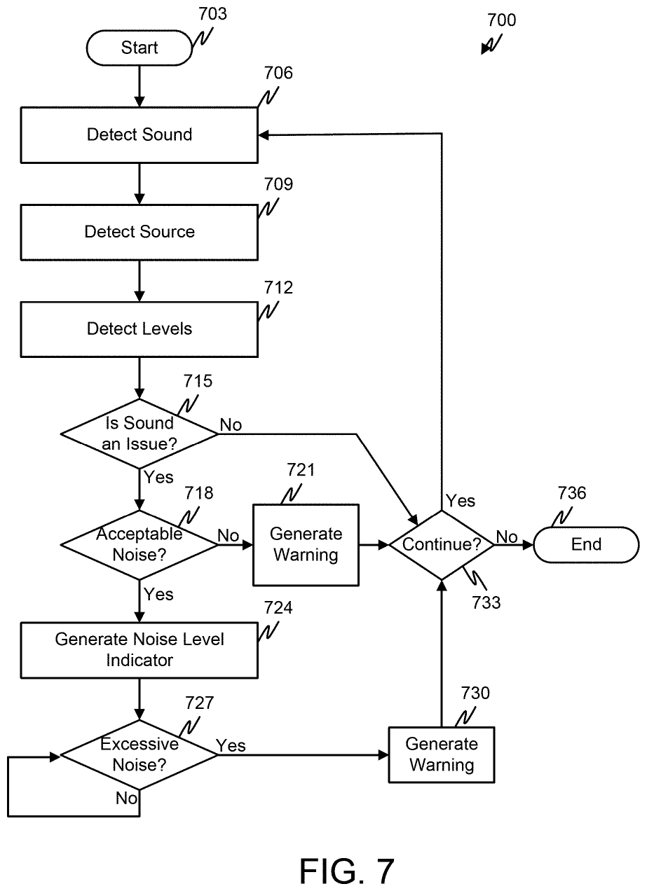

Illustratively, the user communication devices 101A, 101B, the communication applications, the displays, the application(s), may be stored program-controlled entities, such as a computer or microprocessor, which performs the method of FIG. 7 and the processes described herein by executing program instructions stored in a computer readable storage medium, such as a memory (i.e., a computer memory, a hard disk, and/or the like). Although the method described in FIG. 7 is shown in a specific order, one of skill in the art would recognize that the steps in FIG. 7 may be implemented in different orders and/or be implemented in a multi-threaded environment. Moreover, various steps may be omitted or added based on implementation.

In some embodiments, a communication session may comprise two or more users of user devices 101A, 101B, to communicate over the Internet using a communication application such as a video conferencing application. While many of the examples discussed herein deal with video communication, it should be appreciated that these same methods and systems of managing the audio of a communication session apply in similar ways to audio-only communications. For example, the systems and methods described herein may be applied to telephone conversations as well as voice-over-IP communications, video chat applications such as FaceTime or Zoom, or other systems in which two or more users communicate using sound.

Due to processing power requirements to separate an audio signal from a user participating in a communication session into a human voice signal and a noise signal, it is often impractical to separate voice from noise by a user device, i.e. on the client end. Instead, the complete audio signal conventionally is transmitted to a server hosting the communication session, consuming higher network bandwidth than would be required if the audio was recorded in a quiet room. Using a server to separate the noise from voice is often similarly impractical as complex deep learning algorithms may be required to be executed with several iterations in order to accurately separate human voice from noise in the audio.

As described herein, a richer experience may be provided to participants of a communication session using the systems and methods described herein. As described herein, a computer system, such as a user device, may be used to recognize that the speaker using the user device is carrying unwanted noises when the user is actively speaking in the conference or communication session. The computer system may intelligently take action before any manual intervention by the user is required. The action automatically taken by the computer system may in some embodiments be providing a visual noise level indicator (similar to signal strength indicator provided on mobile phone) with appropriate color-coding (e.g., one or two vertical lines in green, a third line in orange and more lines in red colors, etc.), or audible alerts to the participant so the participant may be made aware of how much noise he or she is contributing to the conference. The user may then be enabled to take action such as to move away to a quieter location which is relatively less noisy, avoiding all the complex noise separation steps and thus saving a lot of computation power of conferencing server and also saving the user's own data bandwidth.

The advent in technology, such as artificial intelligence, for example deep learning algorithms or neural networks, relating to voice recognition has made recognizing noise levels versus voice levels possible.

Conventional solutions often require a conference administrator to manually intervene to let the speaker know that he or she is contributing a mixed content signal, i.e., speech along with noise, to a conference. With conventional systems, continuous indication of noise level contribution is not provided to the speaker.

In some embodiments of the present disclosure, computations or determinations for cumulative noise level of all participants in a communication session may take place at a server hosting the communication session. In some embodiments, audio of each participant of the communication session may be separately analyzed by that participant's user device. In some embodiments, a server hosting the communication session may analyze the audio received from each participating user device.

Certain embodiments described herein involve displaying, in an appropriate format, a noise level indicator at a client device of a user participating in the communication session. The noise level indicator may be associated with a determined noise level for all participants of the communication session combined, for each participant separately, or for the individual user of the user device. In some embodiments, the voice-to-noise ratio may be determined for each user device participating in the communication session. For each participant, a share or percentage of the overall, or total, noise may be determined. For example, the server or another computer system may determine that a first participant is currently contributing twenty percent of the overall total noise. The percentage may be determined for each participant. The percentage of noise contribution for a participant may indicate at what magnitude the user is contributing noise (i.e., sound other than voice) to the communication session, regardless of whether the participant is speaking or silent.

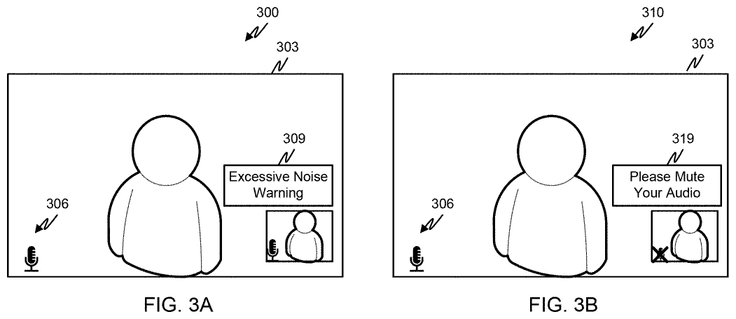

As can be appreciated, users may quickly be able to see whether they are transmitting audio or whether other users can hear audio being transmitted from their microphones as well as be able to see whether other users are sharing audio from their user devices. As illustrated in FIG. 3A, a user interface 300 may be configured to display a warning 309 if excessive noise is detected. In one embodiment, the user interface 300 may be a user interface provided to an administrator to set various configurations as will be described in detail in subsequent figures. The warning 309 may be generated by a server hosting the communication session. The warning 309 may be transmitted to the user device contributing excessive noise to the communication session. In some embodiments, warnings may be provided to other users participating in a communication session. For example, if one particular user is contributing a relatively high level of noise, other users may be presented with a recommendation that the users mute the noisy user.

Similarly, as illustrated in FIG. 3B, a user interface 310 may be configured to display an indication or warning 319 if a user's audio has been determined to include excessive noise. The indication or warning 319 may recommend the user mute his or her audio. For example, if a computer system identifies that the user's audio stream contains excessive noise the user may be presented with a graphical user interface indication with a recommendation that the user him or herself mute his or her audio.

In some embodiments, a user interface 400 may contain a graphical user interface display representing a measurement of noise contained within a user's audio. For example, the user of the user device 101A displaying the user interface 400 may be presented with a graphical user interface illustration of his or her own noise levels in a display 409 of his or her audio signal. Similarly, the user the user device 101A displaying the user interface 400 may be presented with a graphical user interface illustration 412 of the noise levels of the audio of the other user participating in the communication session.

In some embodiments, a user of a user device 101A may be capable of using the user device 101A to communicate with a large number of people participating in a communication session. As illustrated in FIG. 5, a user interface 515 may display a grid 518 of participants of the communication session. The grid 518 of participants may include, for each participant, a display of a video or still image representation of the participant, a microphone illustration indicating whether the participant is sharing his or her audio, and a graphical illustration of the presence of noise in the participant's audio signal. The graphical illustration of the presence of noise in the participant's audio signal may in some embodiments be a bar graph 506, a line graph 509, a gauge 512, a pie chart, or any type of visualization with a low end and a high end capable of illustrating a volume or loudness visualization. In some embodiments, the graphical illustration may simply show a current noise level, for example in the form of a bar graph 506, a gauge 512, etc., or may show a noise level over a particular time period, such as with a line graph 509 showing noise levels over the past few minutes. The graphical illustration of the presence of noise in the participant's audio signal should not be confused with a signal strength indication or network connectivity strength, etc.

As described herein, noise in a user's audio signal may be separated from the user's voice in the audio signal. The separated noise may be used to determine a noise level and/or to calculate a voice-to-noise ratio. For example, an artificial intelligence system may be used. A complete audio signal may be used as an input to the artificial intelligence system which may output a noise signal, i.e., the audio signal without the voice. The noise signal may be used to determine the noise-to-voice ratio.

In some embodiments, a computer system may be capable of determining whether the user is speaking prior to making a noise-to-voice analysis. If no user is determined to be speaking, the computer system may assume all sound is noise. In some embodiments, a computer system may be capable of identifying whether one particular user is an active speaker in the communication session. For example, in a normal communication session it can be assumed that only one user should be expected to be speaking at one time. If two or more users are speaking, a user device participating in the communication session may be capable of identifying which of the two or more users is the active speaker.

In some embodiments, the separation of noise from voice through the use of artificial intelligence or deep learning algorithms may be followed with a determination as to whether the cumulative noise contribution of a participant. The participant may then be provided with a continuous or periodic indication indicating his or her noise contribution. For example, a graphical user interface element may be displayed. The graphical user interface may be a simple graph or chart, such as a bar graph or gauge, illustrating the level of the noise-to-voice ratio of the user's audio signal.

When a user joins a conference or communication session as a participant using a communication application executing on a user device, the communication application may be used to register the user, using a user ID and/or password. with the communication application may also log an endpoint terminal identity for the participant to use to speak during the conference. The user ID and/or endpoint terminal identity may be transmitted to a server hosting the communication session or conference. During the conference, the user device may transmit an audio or audio-visual signal to the server. Using the user ID and/or endpoint terminal identity information, the server may be configured to identify that the signal arriving at the server is for a particular participant.

The user may be capable of selecting a mute feature in a user interface of his or her user device during a communication session. Selecting the mute feature may cease the transmission of the audio from the user device. A graphical user interface mute symbol may be displayed when the user is muted. For example, when the user is transmitting audio, a microphone may be displayed, and when the user is muted the microphone may be displayed as being crossed out.

In some embodiments, a processor of a user device or server may execute a voice characteristics recognition subsystem. The Voice characteristics recognition subsystem may be responsible for recognizing and or capturing characteristics of a user's voice. In some embodiments a voice characteristics recognition subsystem may be executed by a processor of a server hosting the communication session or may be executed by processors of each user device participating in the communication session. In some embodiments, the voice characteristics recognition subsystem may analyze the voice of a user only at times when the user is detected as being the only user speaking at a particular moment during a communication session.

The voice characteristics recognition subsystem may capture a number of characteristics or features of a user's voice. For example, a voice characteristics recognition subsystem may capture loudness or volume, pitch, range, tone, or other features or characteristics of a user's voice. In some embodiments, a voice characteristics recognition subsystem may deploy one or more voice recognition libraries or databases to analyze and or recognize a user's voice.

In some embodiments a processor of a user device or a server participating or hosting a communication session between a plurality of users using user devices may execute a voice separation analysis and processing subsystem. When a user device or server receives an audio signal from a microphone of a user device, the processor of the user device or server may analyze the audio signal in real time to determine whether characteristics detected in the audio signal are associated with a human voice. For example, the processor may analyze the stream to determine whether voice characteristics captured in the stream fall within the human range.

In some embodiments, captured voice characteristic data may be passed through a range checker which may check whether the voice characteristic data falls within the range of a human voice, e.g., 50-70 decibels, whereas external noises such as vehicles honking, vehicles passing by, barking dogs, etc., may have a much higher intensity and higher range than other characteristics.

If at least one of the voice characteristics detected in a user's audio signal does not fall within the human range, the audio signal may be passed through a noise separation subsystem. The noise separation subsystem may employ an artificial intelligence or deep learning algorithm which may be capable of separating out multiple patterns from a voice input. One such algorithm, popularly known as a cocktail party algorithm, separates out multiple voices from a mixture of voices or other sounds. Using such a system, only audio relating to a human voice may be delivered to the server hosting the communication session, whereas the rest of the noises in the original audio signal may be filtered out.

In some embodiments, the noise separation subsystem may run computations on filtered noise to compute factors such as what percentage of noise content exists in an audio signal with respect to actual voice; how long the noise separation subsystem took to separate the noise from the voice; how many iterations of artificial intelligence algorithms were required to separate the noise from the voice; and factors relating to other computations required to calculate the cumulative noise contribution by a particular participant.

Such computations performed by the noise separation subsystem may be carried out for each participant on a cumulative basis either on an absolute basis or relative to past overall noise contributed to the conference. The noise separation subsystem may be configured to determine a current (or average) voice-to-noise (or noise-to-voice) ratio for each participant as well as a percentage of noise contributed by each participant with respect to total noise contributed to a communication session by all participants. Computations performed by the noise separation subsystem may be performed to show, for one or more of the participants of a communication session, a relative overall noise contribution. For example, a participant may be capable of seeing which user participating in the communication session is contributing the most amount of noise or is contributing the highest (or lowest) noise-to-voice ratio at any given time.

In some embodiments, computations may be used as an input to a noise level indicator subsystem. A noise level indicator subsystem may take as input the various computations discussed above and generate various notifications and/or alerts to be provided to the endpoint (e.g., user device) that each participant is using.

Notifications may include a cumulative percentage of noise level contributed to the conference or communication session by each participant which is displayed by the endpoint client in the form of a continuous strength indicator with multiple vertical lines (similar to a signal strength indicator) or a gauge with various color codes. In some embodiments, the noise contribution during a specific time window will be computed and displayed to a user device. For example, a voice-to-noise ratio for a user or a level of the user's noise contribution to the communication session over the last five minutes or other time period. In some embodiments, audible alerts may be generated and provided to the participant in the event that the noise level contribution of the participant has risen above a certain threshold level. Notifications may be in the form of a pop-up window at, for example, the bottom right hand corner indicating that the noise level contribution of the participant exceeds one or more thresholds which may affect the experience of conference.

Using the systems and methods described herein, computation power requirements for hosting a conferencing or communication application are reduced. For example, if half of the noise is reduced, whether due to a participant moving away from noisy place to a relatively quiet place or manually taking actions to reduce the noise, the computation power or system requirements required by the conferencing system may be reduced by a large amount. Since many of today's computer systems are cloud-based and charged on the basis of network- and/or CPU-utilization, the savings in computing resources can directly cut the costs for an organization hosting a communication session or communication application.

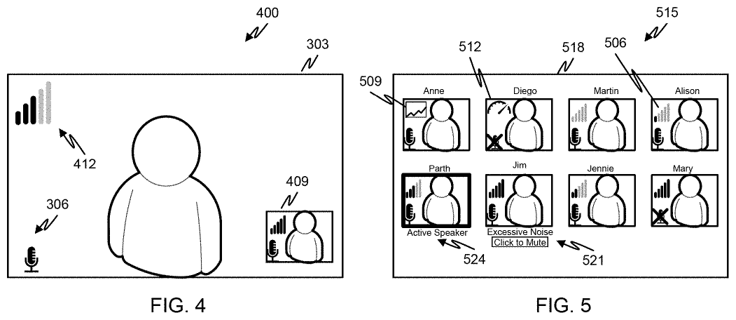

As discussed above, results of noise-to-voice analysis may be displayed to the user via a visualization. A high noise-to-voice ratio may be displayed in the form of five bold vertical bars, while less high noise-to-voice ratio may be displayed in the form of for example three bold vertical bars and two lighter bars as illustrated in FIG. 4. As should be appreciated, the vertical line indicator in the graphical interface illustration 412 is a noise level indicator for a user and is not to be confused with bandwidth/signal strength indicator.

In some embodiments, when excessive noise or a high noise-to-voice ratio is detected a user may be notified in the form of a “click to mute” graphical user interface button 521 or other similar interface element as illustrated in FIG. 5. Similarly, when one user of a plurality of users participating in a communication session is a relatively high contributor of noise, and is also identified as being the active speaker in the conference, the user may be notified with a warning along with a recommendation, for example: a warning such as “you are contributing high noise in the conference, please move closer to microphone” may be displayed.

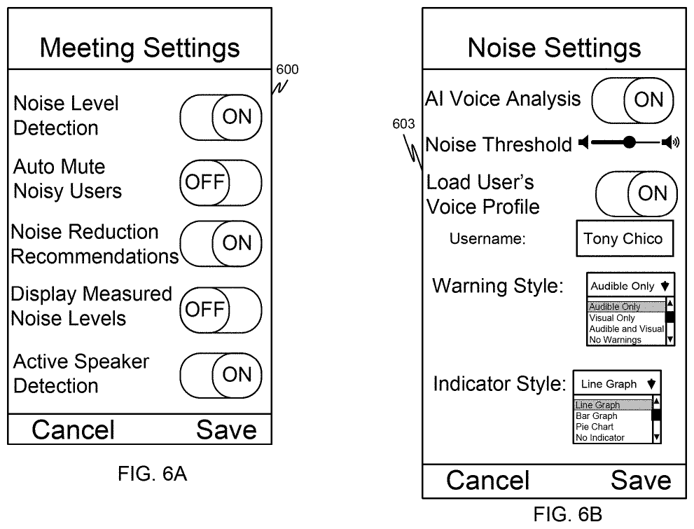

As illustrated in FIG. 6A, a user device configured to execute a communication application may be configured to display a meeting settings user interface 600. The meeting settings user interface 600 may be displayed on a user device during a communication session or outside of a communication session. The meeting settings user interface 600 may be used to control settings during communication sessions executed with a communication application. For example, using a meeting settings user interface 600 a user may be capable of interacting with a number of graphical user interface buttons. Each graphical user interface button may be configured to change a setting relating to a communication session. In some embodiments, a graphical user interface button may be used to activate or deactivate the automatic detection and/or analysis of noise levels. In some embodiments, a graphical user interface button may be used to illustrate a level of noise for users identified as being noisy. In some embodiments, a graphical user interface button may be used to activate or deactivate the automatic presentation of recommendations relating to noise reduction. In some embodiments, a graphical user interface button may be used to activate or deactivate the display of measured noise levels during a communication session. In some embodiments, a graphical user interface button may be used to activate or deactivate the automatic detection of an active speaker during a communication session.

As illustrated in FIG. 6B, a user device configured to execute a communication application may be configured to display a noise analysis settings user interface 603. The noise analysis settings user interface 603 may be displayed on a user device during a communication session or outside of a communication session. The noise analysis settings user interface 603 may be used to control settings during communication sessions executed with a communication application. Using a noise analysis settings user interface 603, a user may be capable of interacting with a number of graphical user interface buttons. Each graphical user interface button may be configured to change a setting relating to a communication session.

In some embodiments, a graphical user interface button of a noise analysis settings user interface 603 may be used to activate or deactivate the use of artificial intelligence or other algorithms to analyze audio signals in a communication session to detect voice. In such embodiment, it would typically be a configuration that would be done by the conference administrator.

In some embodiments, a graphical user interface button of a noise analysis settings user interface 603 may be used to adjust a threshold for noise. The threshold for noise may be adjusted based on decibels or other audio qualities. For example, a maximum amount of noise may be set by a user using a noise analysis settings user interface 603 by adjusting a slider graphical user interface button. The maximum amount of noise setting may be used by a processor of the user device to determine what amount of noise must be detected in an audio signal to trigger a warning in a communication session. While the settings user interface 603 is illustrated as being displayed on a user device participating in a communication session, it should be appreciated that such settings may be adjusted or set on a server-level by a system administrator. In some embodiments, such settings may be set on the server-level and may not be adjusted by individual users.

In some embodiments, a graphical user interface button of a noise analysis settings user interface 603 may be used to load a voice profile for a user. A voice profile for a user may be used by an artificial intelligence system to identify whether audio in an audio signal is a voice of the user or external noises. It should be appreciated that in some embodiments, no voice profile may be required for the analysis.

In some embodiments, a graphical user interface button of a noise analysis settings user interface 603 may be used to adjust a warning style for use in a communication session. For example, a warning may be audio only (e.g., a buzzing noise or a speech recording), visual only (e.g., a graphical user interface pop-up window during a communication session), a combination of audio and video, or no warning at all.

In some embodiments, a graphical user interface button of a noise analysis settings user interface 603 may be used to adjust a style of a noise level indicator for use in a communication session. For example, a noise level indictor may be in the form of a bar graph showing a current noise level (for example similar to a signal strength visualization), a line graph showing noise levels for a past interval of time, a pie chart, or no indicator may be shown at all.

As illustrated in FIG. 7, a process of executing a communication session may be performed by a processor of a user device. In some embodiments, the processor may be of a user device such as a smartphone or personal computer. In some embodiments, a processor of a server or other network-connected device may be used. The process of FIG. 7 may begin at step 703 in which a communication session between two or more user devices has been established. The communication session may be, for example, a video conference using a video conferencing communication application or an audio call using smartphones or voice-over-IP application.

At step 706, a processor of a user device may wait for sound to be detected. Detecting sound may comprise simply receiving an audio signal from a microphone of the user device or from a separate user device. For example, upon joining a communication session, a user device of a user participating in the communication session may activate a microphone. The microphone may begin to collect audio information which may be received by the processor. The audio information may be sent via a network connection and received by a processor of a separate device.

Once sound is detected, some embodiments may comprise detecting a source of the sound at step 709. Detecting a source of the sound may comprise determining whether the sound is associated with a voice or whether the sound is associated with undesirable noises. In some embodiments, detecting a source of the sound may comprise determining whether the sound is coming from the mouth of a user participating in the communication session or whether the sound is coming from a particular type of noise source, e.g., a construction site, a speaker, a television, etc.

At step 712, the processor may detect a noise-level for the sound. Detecting the noise-level of the sound may comprise determining a volume of the sound in decibels. In some embodiments, the levels of the noise may be determined relative to levels of voice detected in the audio signal. For example, the processor may be capable of receiving an audio signal comprising both voice data and noise data. The processor may be capable of separating the noise from the voice to generate a noise signal and a voice signal. The processor may, in detecting the levels, consider only the noise signal.

At step 715, the processor may determine whether the noise is an issue. In some embodiments, determining whether the detected sound is an issue may comprise simply comparing the received sound or audio signal to a threshold number of decibels. In some embodiments, determining whether the detected sound is an issue may comprise comparing a noise signal separated from a voice signal to a threshold number of decibels to determine whether the noise is excessive.

If the sound is determined to be an issue, the process 700 may comprise determining whether the sound contains an acceptable level or an excessive level of noise at step 718. If the processor determines the sound contains an excessive level of noise, the processor may simply generate a warning at step 721. In some embodiments, multiple sound volume thresholds may be used. For example, a higher threshold may be used to determine whether an audible warning should be displayed, and a lower threshold may be used to determine whether a visual warning should be generated. If a warning is generated, the warning may be audible, visual, or a combination of audible and visual.

If the processor determines the sound contains an acceptable level of noise at step 718, the processor may next generate a noise level indicator such as a bar graph, a gauge, or other visualization of a user's noise-to-voice level at step 724. In some embodiments, the noise level indicator may be automatically presenting at the beginning of a communication session or upon detection of a user speaking. It should also be appreciated that the steps illustrated in the flowchart of FIG. 7 and other figures of the present application may be performed in an order other than as illustrated. For example, steps may be performed in any order, not just as illustrated in the flowchart. The noise level indicator may be generated at a server-level and transmitted to each user device participating in the communication conference, or the noise level indicator may be made solely for the benefit of a single user participating in the communication session. After the noise level indicator is generated, the processor may monitor the noise level in the received audio to determine if and when the excessive noise in the audio signal has fallen to a reasonable level or has become excessive. If, at step 727, the processor determines the noise has become excessive, the processor may generate a new warning at step 730.

After either determining the sound in the audio signal is not an issue at step 715 or generating a warning in steps 721 or 730, the process 700 may comprise determining whether the process 700 should continue at step 733. If the process 700 should continue, the process 700 may comprise returning to step 706 in which a sound signal may be detected. If the process 700 should not continue, the process 700 may end at step 736.

As should be appreciated, the above discussion of the process 700 relates to the receiving and analyzing of a single audio signal. The process 700 may be run multiple times simultaneously or in parallel for each audio signal from each participant in a communication session.

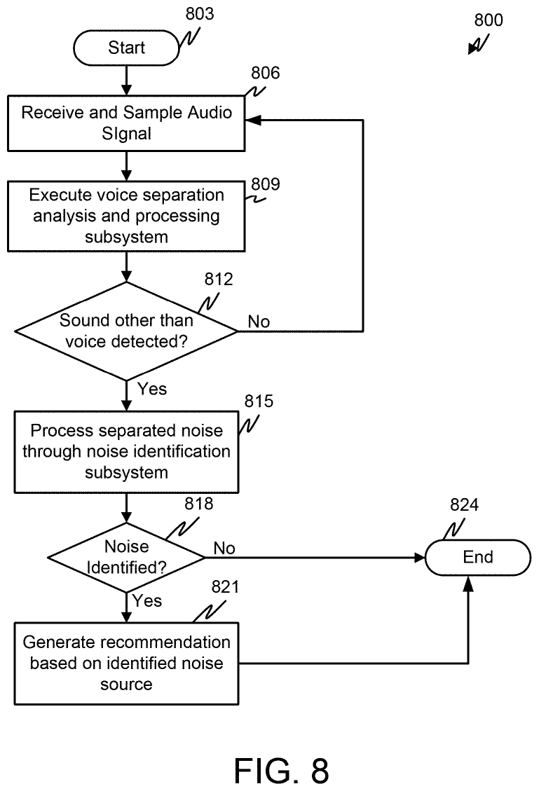

As illustrated in FIG. 8, a process of executing a communication session may be performed by a processor of a user device. In some embodiments, the processor may be of a user device such as a smartphone or personal computer. In some embodiments, a processor of a server or other network-connected device may be used. The process 800 of FIG. 8 may begin at step 803 in which a communication session between two or more user devices has been established. The communication session may be, for example, a video conference using a video conferencing communication application or an audio call using smartphones or voice-over-IP application.

At step 806, a processor, such as a processor of a server hosting the communication session, may receive and sample an audio signal from a user device participating in the communication session. The audio signal may comprise an audio signal from a microphone of a user device participating in the communication session. For example, upon joining a communication session, a user device of a user participating in the communication session may activate a microphone. The microphone may begin to collect audio information which may be received by the processor. The audio information may be sent via a network connection and received by a processor of a separate device.

Once the audio signal is received and sampled, some embodiments may comprise executing a voice separation analysis and processing subsystem at step 809. Using the voice separation analysis and processing subsystem, the processor of the user device or server may analyze the received and sampled audio signal in real time to determine whether characteristics detected in the audio signal are associated with a human voice. For example, the processor may analyze the stream to determine whether voice characteristics captured in the stream fall within the human range.

In some embodiments, the voice separation analysis and processing subsystem may comprise passing voice characteristic data of the audio signal through a range checker which may check whether the voice characteristic data falls within the range of a human voice, e.g., 50-70 decibels, whereas external noises such as vehicles honking, vehicles passing by, barking dogs, etc., may have a much higher intensity and higher range than other characteristics.

In some embodiments, the voice separation analysis and processing subsystem may employ an artificial intelligence or deep learning algorithm which may be capable of separating out multiple patterns from an input. One such algorithm, popularly known as a cocktail party algorithm, separates out multiple voices from a mixture of voices or other sounds.

At step 812, the process 800 may comprise determining whether the received audio signal contains sound other than voice. For example, if at least one of the voice characteristics detected in a user's audio signal does not fall within the human range, the processor may determine sound other than voice has been detected. If no sound other than voice has been detected, the process 800 may comprise returning to step 806 and receiving additional audio from a user device participating in the communication session.

If sound other than voice has been detected, the process 800 may comprise separating the noise in the audio signal from the voice in the audio signal. The separated noise signal may be passed through a noise identification subsystem in step 815. In some embodiments, the separated noise may be analyzed with prerecorded noise samples to identify what kind of noise is contained in the audio signal. In this way, a specific warning may be provided to the user providing the audio.

In some embodiments, the processor may be configured to compare noise signal data with prerecorded samples of noise sources such as a vehicle honking, a vehicle passing by, a dog barking, birds chirping, a baby crying, an air conditioner compressor, a fan running, etc.

The noise identification subsystem may be an artificial intelligence-based system trained using a number of noise samples with respective sound characteristics. The noise identification subsystem trained with numerous samples of noise sources may use the training data to identify whether the noise signal data is similar in characteristics to any of the samples used in the training data. If the noise identification subsystem can identify the noise contained in the noise signal data as being associated with one or more noises, the process may proceed to step 821. In some embodiments, a threshold level of association may be required to proceed to step 821. For example, a particular degree of certainty or confidence may be required by the processor to generate a recommendation to the user. If no noise source is identified, or the processor has not identified the noise to a particular degree of certainty or confidence, the process may end at step 824.

At step 821, if a noise source has been identified or has been estimated to a particular degree of certainty or confidence, a warning may be provided to the user. For example, the processor may provide an identification of the identified noise to an alerting subsystem. The alerting subsystem may be configured to inform the user about the specific noise source identified in the user's audio signal and provide the user with a warning that the noise being contributed by the user contains the specific noise source. For example, the alerting subsystem may inform the user the user's audio contains the sound of a dog barking, vehicle noises, etc. In some embodiments, a recommendation may be provided to the user, for example providing the user with instructions for reducing noise by replacing a microphone, turning off an air conditioner or fan, closing a window, etc.

Embodiments of the present disclosure include a method for controlling sound quality of a communication session, the method comprising: receiving, with a processor, audio from a first user device associated with a first user participating in the communication session; determining, by the processor, the audio comprises a level of noise; determining, by the processor, the level of noise exceeds a threshold level; and based on determining the level of noise exceeds the threshold level, one or more of: generating, by the processor, a warning for the first user; and generating, by the processor, a graphical illustration of the level of noise for the first user in the communication session

Aspects of the above method include wherein the processor is of a server hosting the communication session.

Aspects of the above method include wherein determining the level of noise exceeds the threshold level comprises analyzing a noise-to-voice ratio for the audio.

Aspects of the above method include wherein the processor is of a second user device associated with a second user participating in the communication session, the method further comprising displaying a recommendation that the second user manually mute the first user.

Aspects of the above method include wherein determining the audio comprises the level of noise comprises processing the received audio with a neural network to separate voice data from noise data.

Aspects of the above method include wherein the determination that the level of noise exceeds the threshold level is not related to the voice data.

Aspects of the above method include the method further comprising generating a graphical illustration of the level of noise for display on the first user device.

Aspects of the above method include the method further comprising determining the level of noise is unrelated to a voice of the first user.

Aspects of the above method include the method further comprising determining the first user is an active speaker in the communication session.

Aspects of the above method include wherein determining the first user is the active speaker comprises capturing loudness, pitch, range, and tone data associated with the received audio.

Aspects of the above method include wherein the communication session is one of a voice communication and a video communication.

Aspects of the above method include wherein the warning is one or more of a visual message and an audible message.

Aspects of the above method include the method further comprising determining a noise level contribution for each of a plurality of users participating in the communication session.

Aspects of the above method include the method further comprising generating a graphical illustration of the noise level contribution for each of the plurality of users participating in the communication session.

Aspects of the above method include the method further comprising determining a source of noise in the audio.

Aspects of the above method include wherein the warning for the first user comprises an identification of the determined source of noise in the audio.

Embodiments of the present disclosure include a system for monitoring and/or controlling sound quality of a communication session, the system comprising: a processor; and a computer-readable storage medium storing computer-readable instructions which, when executed by the processor, cause the processor to: receive audio from a first user device associated with a first user participating in the communication session; determine the audio comprises a level of noise; determine the level of noise exceeds a threshold level; and based on determining the level of noise exceeds the threshold level, one or more of: generate a warning for the first user; and generate a graphical illustration of the noise.

Aspects of the above system include wherein determining the audio comprises the level of noise comprises processing the received audio with a neural network to separate voice data from noise data.

Aspects of the above system include wherein the instructions further cause the processor to determine a noise level contribution for each of a plurality of users participating in the communication session.

Aspects of the above system include wherein the instructions further cause the processor to generate a graphical illustration of the noise level contribution for each of the plurality of users participating in the communication session.

Embodiments of the present disclosure include a computer program product for controlling sound quality of a communication session, the computer program product comprising a non-transitory computer-readable storage medium having computer-readable program code embodied therewith, the computer-readable program code configured, when executed by a processor, to: receive audio from a first user device associated with a first user participating in the communication session; determine the audio comprises a level of noise; determine the level of noise exceeds a threshold level; and based on determining the level of noise exceeds the threshold level, one or more of: generate a warning for the first user; and generate a graphical illustration of the noise contributions of the first user device in the communication session.

Examples of the processors as described herein may include, but are not limited to, at least one of Qualcomm® Snapdragon® 800, 810, 820, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM1926EJ-S™ processors, Rockchip RK3399 processor, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub-combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for monitoring and controlling sound quality of a communication session, the method comprising:
receiving, with a processor, audio from a first user device associated with a first user participating in the communication session;
determining, by the processor, the audio comprises a level of noise;
generating, by the processor, a graphical illustration of the level of noise for the first user in the communication session;
determining, by the processor, the level of noise exceeds a threshold level; and
based on determining the level of noise exceeds the threshold level, generating, by the processor, a warning for the first user.

2. The method of claim 1, wherein determining the level of noise exceeds the threshold level comprises analyzing a noise-to-voice ratio for the audio.

3. The method of claim 1, further comprising generating a warning or recommendation for a second user device associated with a second user participating in the communication session.

4. The method of claim 1, wherein determining the audio comprises the level of noise comprises processing the received audio with a neural network to separate voice data from noise data.

5. The method of claim 4, wherein the determination that the level of noise exceeds the threshold level is not related to the voice data.

6. The method of claim 1, further comprising generating a graphical illustration of the level of noise for display on the first user device.

7. The method of claim 1, further comprising determining the level of noise is unrelated to a voice of the first user.

8. The method of claim 1, further comprising determining the first user is an active speaker in the communication session.

9. The method of claim 8, wherein determining the first user is the active speaker comprises capturing loudness, pitch, range, and tone data associated with the received audio.

10. The method of claim 1, wherein the communication session is one of a voice communication and a video communication.

11. The method of claim 1, wherein the warning is one or more of a visual message and an audible message.

12. The method of claim 1, further comprising determining a noise level contribution for each of a plurality of users participating in the communication session.

13. The method of claim 12, further comprising generating a graphical illustration of the noise level contribution for each of the plurality of users participating in the communication session.

14. The method of claim 1, further comprising determining a source of noise in the audio.

15. The method of claim 14, wherein the warning for the first user comprises an identification of the determined source of noise in the audio.

16. The method of claim 1, wherein the graphical illustration of the level of noise comprises a color representing the level of noise.

17. A system for monitoring and controlling sound quality of a communication session, the system comprising:
a processor; and
a computer-readable storage medium storing computer-readable instructions which, when executed by the processor, cause the processor to:
receive audio from a first user device associated with a first user participating in the communication session;
determine the audio comprises a level of noise;
generate a graphical illustration of the level of noise for the first user in the communication session;
determine the level of noise exceeds a threshold level; and
based on determining the level of noise exceeds the threshold level, generate a warning for the first user.

18. The system of claim 17, wherein determining the audio comprises the level of noise comprises processing the received audio with a neural network to separate voice data from noise data.

19. The system of claim 17, wherein the instructions further cause the processor to determine a noise level contribution for each of a plurality of users participating in the communication session.

20. A computer program product for monitoring and controlling sound quality of a communication session, the computer program product comprising a non-transitory computer-readable storage medium having computer-readable program code embodied therewith, the computer-readable program code configured, when executed by a processor, to:
receive audio from a first user device associated with a first user participating in the communication session;
determine the audio comprises a level of noise;
generate a graphical illustration of the level of noise for the first user in the communication session;
determine the level of noise exceeds a threshold level; and
based on determining the level of noise exceeds the threshold level, generate a warning for the first user.
